(19) United States
(12) Patent Application Publication
(10) Pub. No.: US 2024/0170695 A1
(43) Pub. Date: May 23, 2024

(54) FUEL CELL WITH INTEGRATED BALANCE OF PLANT COMPONENTS

(71) Applicant: ZeroAvia, Inc., Hollister, CA (US)

(72) Inventors: Aleksey PETLENKO, Hollister, CA (US); Asif Mohammad SADIK, Swindon (GB); Jonathan Leopold Nutzati FONTAINE, South San Francisco, CA (US)

(21) Appl. No.: 18/056,651

(22) Filed: Nov. 17, 2022

(51) Int. Cl. H01M 8/04119; H01M 8/04111; H01M 8/2483; H01M 8/249

(52) U.S. Cl. CPC H01M 8/04126; H01M 8/04111; H01M 8/2483; H01M 8/249; B64D 2041/005; H01M 2250/20

(57) ABSTRACT

A fuel cell system includes a plurality of fuel cell stacks mechanically and electrically assembled to one another to provide a desired power and output voltage, and including a humidifier directly mated to inlet and outlet ports the individual fuel cell stacks.

### TECHNICAL FIELD

The present disclosure relates to hydrogen fuel cells. The disclosure has particular utility for hydrogen fuel cells for use in powering electric engines for transport vehicles including aircraft and will be described in connection with such utility, although other utilities are contemplated.

### BACKGROUND AND SUMMARY

This section provides background information related to the present disclosure which is not necessarily prior art. This section provides a general summary of the disclosure and is not a comprehensive disclosure of its full scope or all its features.

A fuel cell is an electrochemical cell that converts chemical energy into electrical energy by electrochemical reduction-oxidation (redox) reactions. Fuel cells include an anode and a cathode separated by a membrane and an ionically conductive electrolyte. During operation, a fuel (e.g., hydrogen) is supplied to the anode and an oxidant (e.g., oxygen or air) is supplied to the cathode. The fuel is oxidized at the anode, producing positively charged ions (e.g., hydrogen ions) and electrons. The positively charged ions travel through the electrolyte from the anode to the cathode, while the electrons simultaneously travel from the anode to the cathode outside the cell via an external circuit, which produces an electric current. The oxidant supplied to the cathode is reduced by the electrons arriving from the external circuit and combines with the positively charged ions to form water. The reaction between oxygen and hydrogen is exothermic, generating heat that needs to be removed from the fuel cell.

Fuel cells may be used as power sources for electric motors of electric vehicles and hybrid electric vehicles, including aircraft. In such applications, fuel cells oftentimes are arranged in stacks of multiple cells and connected in a series or parallel arrangement to achieve a desired power and output voltage. However, a common problem with conventional fuel cell systems is that specific, uniform operating conditions (e.g., humidity) must be maintained through the stack. Fuel cell systems include humidifiers for providing heat and humidity to the incoming oxidant or hydrogen fuel stream. Without humidification, the fuel cell membrane may become too dry which reduces proton transport in the fuel cell stack and decreases the oxygen reduction reaction at the cathode, resulting in poor fuel cell function or even failure. Also, while central cells in a stack can be maintained at essentially uniform conditions, cells at either end of the stack may operate at less than optimum conditions. As a result, the fuel cells at either end of the stack cells have a tendency to become flooded, and as a consequence, to have decreased efficiency and performance. Thus, balance of fluid management of inputs and outputs for hydrogen, air and coolant is critical.

Also, as in the case of hydrogen fuel cell powered aircraft, as aircraft power demand increases, fuel cells used on aircraft contribute significantly to the total weight and size of the aircraft which also increases drag, imposing penalties on speed, range and efficiency of the aircraft. This problem is exacerbated as more fuel cells are installed. A critical challenge in this regard is that the more stacks installed, the more weight and space required for the auxiliary systems that are required such as humidification systems and the associated hoses and ducting, etc., that make up the balance of the fuel cell system, i.e., the so-called “Balance of Plant” (BOP). That is to say, the more fuel cell stacks installed, the larger the BOP in weight and size of the various supporting components and auxiliary systems including humidifiers needed for proper function and operation of the fuel cells.

Current state of the art humidifiers for fuel cells usually are designed as counter-flow devices, meaning the moist air flows through the humidification chamber in the opposite direction to the dry air within the tubes being humidified. Counter-flow arrangements are preferred since they provide a 20% higher rate of humidification relative to non-counterflowing arrangements. What this means from a practical packaging perspective is that both of the ports that interface to a fuel cell stack, i.e., the air outlet and the moist air inlet, are in close proximity to each other, and on the same side of the humidification chamber, while the two ports on the other side of the humidification chamber, i.e., the humidifier inlet from air compressor and humidifier exhaust outlet, need to be routed away. This imposes spatial arrangement restrictions on how the humidifier can be laid out relative to the fuel cell stack.

Referring to FIG. 1, conventional humidifiers 10, as sold by humidifier manufacturers worldwide, typically consist of an inlet expander section 12, a humidification chamber 14 and an outlet nozzle section 16. The inlet expander section 12 is a channel that serves to change the direction and shape of the airflow from a circular inlet hose-port 18 on the bottom of the humidifier housing for introduction of pressurized air from the fuel cell system compressor, to match the rectangular cross section 20 going forward into the humidifier humidification chamber 14. The outlet nozzle section 16 performs the opposite function, funneling the now humidified outlet air back from the humidifier rectangular cross section 22 to a downward facing circular hose port 24 on the bottom of the humidifier housing for introducing the humidifier air to the fuel cell stack. The humidification chamber 14 has two more circular, downward-facing ports, an inlet port 26 for introducing moist air from the fuel cell stack exhaust, and an outlet port 28 for the spent air to exit. Because the fuel cell ports are downward facing, and the outlet ports of a conventional humidifier also are downward facing, space is needed to turn the flows 180°, which subject to the minimum turn radius of the connecting hoses is also very space consuming and adds unnecessary hose length. Shorter hoses and channels lower the weight, volume and pressure loss in tubing allowing for higher performance and power density of the system. This design adds to the BOP.

Existing approaches combine multiple independent fuel cell stacks to achieve required power and voltage. However, multiple independent fuel cell stacks must each be supported with their own BOP components, mounting structure and properly scaled flow channels creating material redundancy. The opportunity exists to consolidate where possible multiple smaller components can be combined to a larger, more space efficient component, particularly given the requirement to turn the flows 180° discussed previously. In accordance with the present disclosure, we provide “superstacks” of multiple fuel cell stacks tightly mechanically assembled together. We also provide a single, large-sized, novel humidifier that is configured to directly mate to the fuel cell stacks making up the superstack.

The balance of plant (BOP) is sized, consolidated and packaged at the superstack level. BOP includes fluid management of inputs and outputs for hydrogen, air and coolant. As so provided, the mass (weight) and volume of the BOP is reduced as compared to conventional fuel cell systems of comparable capacity.

In a preferred embodiment, our superstack comprises three fuel cell stacks tightly mechanically assembled together. The fuel cell superstack has three air inlets configured to be fed from the output of the humidifier and three air exhausts configured to feed the moist air inlet on the humidifier. Since these are 3-1 interfaces, a 3-1 manifold is required on each.

In accordance with the present disclosure we provide a humidifier with a bespoke air routing, i.e., humidifier having a novel integral manifold configured to directly connect the humidifier to the multiple inlets of the fuel cell superstacks, thereby eliminating substantial weight and volume of hoses and ducting making up a conventional fuel cell system BOP. More particularly, because a humidifier outlet's primary function is to route the outlet air from the humidifier to a single port of circular cross section of the fuel cell, we have designed our humidifier integral manifold to split the flow from the humidifier to the three inlets on the fuel cell superstack as a direct mate. In similar fashion, we provide a novel compact manifold for connecting the multiple fuel cell exhaust outlets of our fuel cell superstack to a single outlet port.

Additionally, the BOP's sensor's and valves can be integrated directly into their ideal locations in the novel compact manifold.

More particularly, in one aspect we provide a fuel cell system comprising a plurality of fuel cell stacks mechanically and electrically assembled to one another to provide a desired power and output voltage, and including a humidifier directly mated to inlet ports of the individual fuel cell stacks. In one aspect the fuel cell system comprises three fuel cell stacks electrically connected in series, or three fuel cell stacks electrically connected in parallel.

In one aspect the fuel cell system comprises an air compressor, wherein the humidifier includes an inlet section having an inlet configured for fluid connection to the air compressor.

In another aspect the humidifier is directly mated to the fuel cell stack to introduce humid air to the fuel cell stack at an anode side of fuel cells in the fuel cell stack.

In still yet another aspect the humidifier is directly mated to the fuel cell stack to introduce humid air to the fuel cell stack at a cathode side of fuel cells in the fuel cell stack.

In one aspect exhaust from the fuel cells in the fuel cell stack is directly routed to an inlet port of the humidifier.

In another aspect the humidifier includes an outlet directly connected via an integral manifold to inlet ports of the fuel cells in the fuel cell stack.

In a further aspect the humidifier comprises a counter-flow humidifier.

In yet another aspect, we directly mate and connect the exhaust from plural fuel cell stacks to the inlet port of the humidifier.

In a further aspect we provide a method for reducing the weight and volume of a fuel cell system comprising a plurality of fuel cells and humidifier, comprising mechanically and electrically assembling a plurality of fuel cell stacks to one another to provide a desired power and output voltage, and directly mating the humidifier to inlet and outlet ports of the individual fuel cell stacks.

In one aspect of the method the fuel cell stacks are electrically connected in series.

In one aspect of the method the fuel cell stacks are electrically connected arranged in parallel.

In a further aspect of the method the fuel cell system comprises an air compressor, and including the step of directing air from the air compressor into an inlet section of the humidifier.

In one aspect of the method humid air from the humidifier is introduced at an anode side of fuel cells in the fuel cell stack.

In yet another aspect of the method humid air from the humidifier is introduced at a cathode side of fuel cells in the fuel cell stack.

In yet a further aspect of the method exhaust from the fuel cells in the fuel cell stack is directly routed to an inlet port of the humidifier.

In yet another aspect of the method the humidifier includes an outlet directly connected via an integral manifold to inlet ports of the fuel cells in the fuel cell stack.

In a further aspect of the method the humidifier comprises a counter-flow humidifier.

In yet another aspect we provide a fuel cell powered aircraft comprising a fuel cell system, comprising a plurality of fuel cell stacks together and mechanically and electrically connected including a humidifier directly mated to inlet ports of the fuel cell stacks.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings. The drawings described herein are for illustrative purposes only of selected embodiments and not all possible implementations and are not intended to limit the scope of the present disclosure.

FIG. 1 is a cross sectional view of a conventional fuel cell system humidifier;

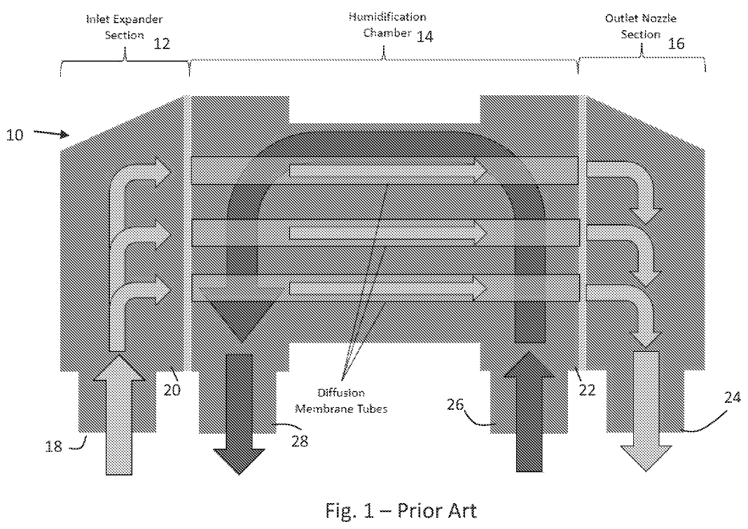

FIG. 2 is a perspective view of a three fuel cell “superstack” in accordance with the present disclosure;

FIG. 3 is a side elevational view of a fuel cell superstack and including a humidifier directly mated to the inlet ports of the fuel cell stack in accordance with the present disclosure;

and

FIG. 4 is a schematic view of a hydrogen gas fuel cell powered airplane having a novel humidifier in accordance with the present disclosure.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

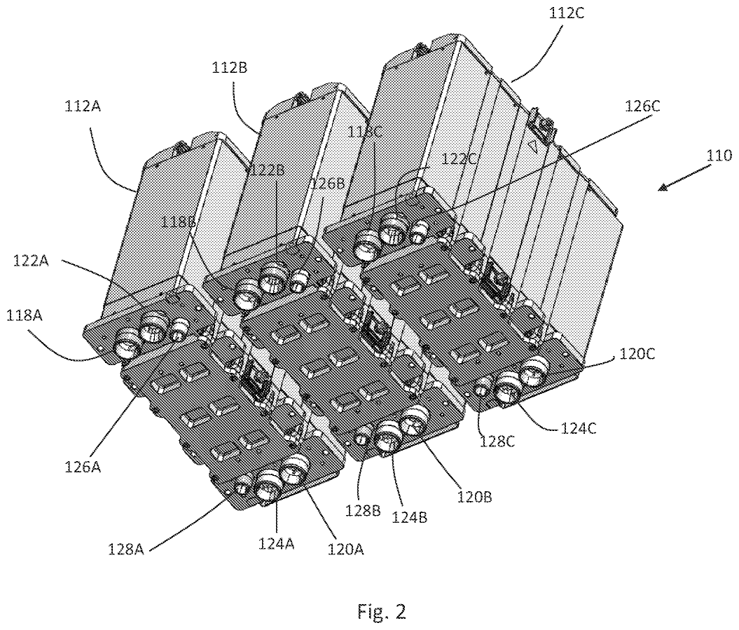

Referring to FIG. 2, a fuel cell system in accordance with the present disclosure includes a superstack 110 of three fuel cell stacks 112A, 112B, 112C. Fuel cell stacks 112A, 112B, 112C are connected in series and/or parallel to achieve a desired output voltage and current. The electrical connectors connecting fuel cell stacks 112A, 112B, and 112C are conventional and are not shown. Fuel cell stacks 112A, 112B, 112C each include an air inlet 118A, 118B, 118C configured for introduction of humidified air from a humidifier as will be described below, and air outlets 120A, 120B, 120C via which air is exhausted from the fuel cell stacks. Fuel cell stacks 112A, 112B, 112C also include air inlets 122A, 122B, 122C configured for introduction of pressurized air from the fuel cell system compressor (also not shown), and spent air outlets 124A, 124B, 124C configured to direct humid air exhaust from the cells 112A, 112B, 112C. The fuel cell stack 112A, 112B, 112C also include coolant inlets 126A, 126B, 126C, and coolant recirculation outlets 128A, 128B, 128C.

As a practical matter, the fuel cell stacks are oriented downward in use, so that any water created in the reaction or condensing from the humidified air input drains from the cells.

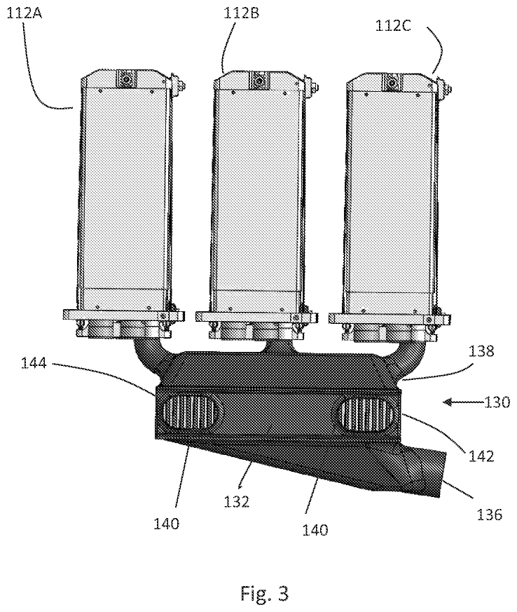

Referring to FIG. 3, the fuel cell system also includes a humidifier 130 having a housing section 132 having a humidification chamber in the form of a hollow chamber. Humidifier 130 includes an air inlet port 136 for introducing air from the fuel cell system compressor (not shown) into the humidifier, and an integrated air outlet manifold section 138 via which humidified air is withdrawn and introduced into the inlets of the fuel cell stacks 112A, 112B, 112C. A plurality of diffusion membrane tubes 140 are located within housing 138 for carrying the air introduced from the compressor through the humidifier and into the air outlet manifold section 138 for introduction into the fuel cell stacks.

Humid air from the fuel cell exhaust is introduced into the humidification chamber hollow chamber 134 via inlet 142, gives up water through the diffusion membrane tubes 140 to humidify the inlet air, and exits the humidifier via humidifier outlet 144 to exhaust.

A similarly shaped manifold, without the diffusion membrane tubes routes spent air, unreacted hydrogen, etc., from the fuel cell stacks.

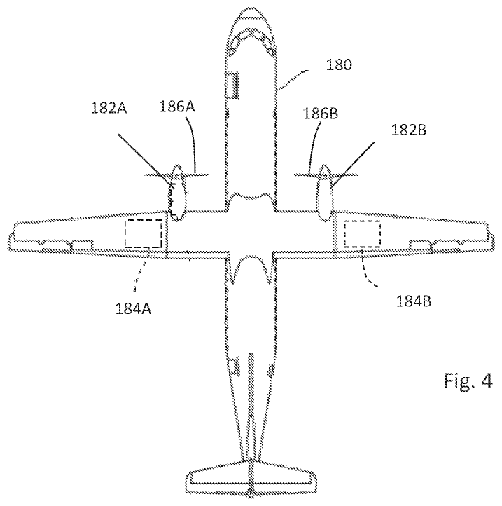

FIG. 4 illustrates an airplane 180 which includes two electric motors 182A, 182B which are supplied by two hydrogen fuel cell system 184A, 184B including humidifier system in accordance with the preferred disclosure.

In one embodiment a superstack and the BOP are packaged as a modular cuboid standard subsystem for installation into a variety of aircraft.

Placing the humidifier, facing down, next to the superstack module increases the lateral size of the packaged BOP, making it harder to fit on the airplane. It also, must still occupy the space below to route the air 180° underneath.

Another packaging technique could be to place the humidifier under the superstack/BOP subsystem. With a conventional humidifier, this creates an irregular shape as only half of the humidifier (the wet inlet and dry outlet) are under the superstack cube, and the dry inlet and wet outlet must protrude out of the envelope.

To minimize volume requirements we may customize the aspect ratio of the humidifier and the inlet/outlet configurations such that it can occupy the volume immediately below the superstack cube with the shortest possible tube routing and lowest overall volume.

One packaging technique is to provide a slim humidifier that, in an inlets-down orientation, trades width for both height and depth. This slim humidifier can occupy a similar lateral envelope to the superstack such that it stacks neatly beneath it when placed on its side, or alternatively if placed in a vertical orientation next to or in front of the superstack, adds the least width possible to the superstack's horizontal envelope.

A further possibility is to integrate the humidifier's core directly into the structure of the inlet manifold of the fuel cell stack. This saves on structural material and mass by sharing walls between flow channels and decreases the maximum overall height of the Superstack/BOP package.

Fluid management occurs in the triple fluid management manifold or ‘mono-manifold’ as referred to herein. This mono-manifold is a single structure containing all flow channels valves, injectors and sensors included in the BOP for all 3 fluids. The mono-manifold can take on one of two forms: 1) mated to a humidifier, possibly with custom intake ports, mounted underneath or next to the fuel cell BOP, or 2) the humidifier core, the membrane tube bundle, is installed directly into a fully integrated compartment of the mono-manifold.

The mono-manifold may be manufactured through a sandwich design wherein multi-layer 2D flow channels and interfaces are machined into flat stacking plates of a suitable material, e.g., aluminum, titanium, stainless steel or plastic and bonded together. In another embodiment, the mono-manifold may be manufactured through a spaghetti design wherein the techniques of Stereolithography 3D printing (SLA) and/or Selective Laser Sintering (SLS) are used to form complex 3D flow channels and structures in aluminum, plastic, stainless steel, and/or titanium.

Metal mono-manifolds may be coated in insulative material to reduce conductivity. Additive methods may use a coating or surface treatment to reduce porosity (e.g., MEK bath for polycarbonate parts reduces porosity and increases smoothness).

As can be seen from the foregoing disclosure as a result of our novel superstack arrangement of multiple fuel cell stacks, coupled with the novel humidifier with integral manifold which permits us to directly mate our humidifier to the inlet ports of the individual fuel cell stacks, the BOP of our fuel cell system is significantly reduced in size and weight as compared to a conventional fuel cell system.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

1. A fuel cell-powered aircraft comprising one or more electric motors configured to drive propulsors, and a plurality of fuel cell stacks mechanically and electrically assembled to one another and configured to provide a desired power and output voltage to said one or more electric motors, said fuel cell stacks including a humidifier having a core comprising a plurality of diffusion membrane tubes, directly mated to inlet and outlet ports of the individual fuel cell stacks, wherein the humidifier core is integrated directly into an inlet manifold of the plurality of fuel cell stacks, and wherein the manifold comprises a single outlet port whereby to minimize a size and weight of the manifold.

2. The fuel cell system of claim 1, wherein the plurality of fuel cell stacks are electrically connected in series, or in parallel.

3. The fuel cell system of claim 1, further comprising an air compressor, wherein the humidifier includes an inlet section having an inlet configured for fluid connection to the air compressor.

4. The fuel cell system of claim 1, wherein the humidifier is directly mated to the fuel cell stack to introduce humidified air to the fuel cell stack at a cathode side of fuel cells in the fuel cell stack.

5. The fuel cell system of claim 1, wherein exhaust from the fuel cells in the fuel cell stack is directly routed to an inlet port of the humidifier.

6. The fuel cell system of claim 1, wherein the humidifier includes an outlet directly connected via an integral manifold to inlet ports of the fuel cells in the fuel cell stack.

7. The fuel cell system of claim 1, wherein the humidifier includes an inlet directly connected via an integral manifold to outlet ports of the fuel cells in the fuel cell stack.

8. The fuel cell system of claim 1, wherein the humidifier comprises a counter-flow humidifier.

9. The fuel cell system of claim 1, wherein the plurality of fuel cell stacks and the humidifier are packaged as a modular subsystem.

10. The fuel cell system of claim 1, wherein the humidifier core is integrated into an inlet manifold of the fuel cell stack.

11. A method for reducing the weight and volume of a fuel cell system powering an aircraft, wherein said aircraft comprises one or more electric motors configured to drive propulsors, and a plurality of fuel stacks mechanically and electrically assembled to one another and configured to provide a desired power and output voltage to said one or more electric motors, wherein said fuel cell stacks include and a humidifier having a core comprising a plurality of diffusion membrane tubes, comprising mechanically and electrically assembling a plurality of fuel cell stacks to one another to provide a desired power and output voltage, and directly mating the humidifier to inlet and outlet ports of the individual fuel cell stacks, wherein the humidifier core is integrated directly into an inlet manifold of the plurality of fuel cell stacks, and wherein the manifold comprises a single output port whereby to minimize a size and weight of the manifold.

12. The method of claim 11, wherein the fuel cell stacks are electrically connected in series, or in parallel.

13. The method of claim 11, wherein the fuel cell system comprises an air compressor, and including the step of directing air from the air compressor into an inlet section of the humidifier.

14. The method of claim 11, wherein humidified air from the humidifier is introduced at a cathode side of fuel cells in the fuel cell stack.

15. The method of claim 11, wherein exhaust from the fuel cells in the fuel cell stack is directly routed to an inlet port of the humidifier.

16. The method of claim 11, wherein the humidifier includes an outlet directly connected via an integral manifold to inlet ports of the fuel cells in the fuel cell stack.

17. The method of claim 11, wherein the humidifier comprises a counter-flow humidifier.

18. The method of claim 11, wherein the plurality of fuel cell stacks and the humidifier are packaged as a modular subsystem.

19. The method of claim 11, wherein the humidifier core is integrated into an inlet manifold of the fuel cell stack.

20. (canceled)
